(19) United States
(12) Patent Application Publication
(10) Pub. No.: US 2021/0207705 A1
(43) Pub. Date: Jul. 8, 2021

(54) INTEGRATED OIL CAPTURE AND GASKET SYSTEM

(71) Applicant: GM GLOBAL TECHNOLOGY OPERATIONS LLC, Detroit, MI (US)

(72) Inventors: Chad R. Brizendine, Fenton, MI (US); David S. Schulz, Livonia, MI (US); Ronald G. Mattise, Davisburg, MI (US)

(73) Assignee: GM GLOBAL TECHNOLOGY OPERATIONS LLC, Detroit, MI (US)

(21) Appl. No.: 16/734,963

(22) Filed: Jan. 6, 2020

(51) Int. Cl. F16H 57/04; F16H 57/02; F16H 57/029

(52) U.S. Cl. CPC F16H 57/0452; F16H 2057/02052; F16H 57/029; F16H 57/02

(57) ABSTRACT

A system for retaining and redistributing a fluid includes a capture member including a recessed surface defining a reservoir and a sealing surface extending around a perimeter of the recessed surface, the sealing surface including a plurality of fastener openings, a sealing member adjacent to and coupled with the sealing surface of the capture member, the sealing member encircling the plurality of fastener openings, a cover member coupled to the capture member, and at least one fastener coupling the cover member to the capture member. The cover member and the capture member compressively secure the sealing member therebetween to retain the fluid between the cover member and the capture member.

### INTRODUCTION

The present disclosure relates generally to an integrated oil capture and gasket system.

Oil capture and redistribution in vehicle components, such as a rear drive module (RDM) is typically accomplished by machining or casting pockets and passages within the module housing. A stand-alone gasket or press-in-place seal is used to seal the housing to prevent oil leakage. However, machining or casting pockets and passages in the module housing adds manufacturing complexity and may not result in efficient oil capture and redistribution.

### SUMMARY

Embodiments according to the present disclosure provide a number of advantages. For example, embodiments according to the present disclosure enable capture and redistribution of oil within a housing, such as a rear drive module housing, for targeted oil distribution as well as sealing a surface between two mating components of the housing.

In one aspect of the present disclosure, a system for retaining and redistributing a fluid includes a capture member including a recessed surface defining a reservoir and a sealing surface extending around a perimeter of the recessed surface, the sealing surface including a plurality of fastener openings, a sealing member adjacent to and coupled with the sealing surface of the capture member, the sealing member encircling the plurality of fastener openings, a cover member coupled to the capture member, and at least one fastener coupling the cover member to the capture member. The cover member and the capture member compressively secure the sealing member therebetween to retain the fluid between the cover member and the capture member.

In some aspects, the capture member includes a first edge adjacent to and contiguous with each of the sealing surface and the recessed surface such that the sealing surface and the recessed surface are non-coplanar.

In some aspects, the capture member includes a second edge defining a redistribution opening to redistribute captured fluid.

In some aspects, the second edge is formed in the recessed surface of the capture member.

In some aspects, the sealing member is a compression gasket.

In some aspects, the sealing member includes a plurality of sealing member openings configured to align with the plurality of fastener openings formed in the sealing surface of the capture member.

In some aspects, the sealing member is adhesively coupled to the sealing surface of the capture member.

In some aspects, the sealing member is removably coupled to the sealing surface of the capture member.

In some aspects, the at least one fastener is a cover bolt.

In some aspects, the plurality of fastener openings in the capture member are evenly distributed around the recessed surface.

In another aspect of the present disclosure, a system for retaining and redistributing a fluid includes a capture and sealing member including a sealing portion and a vertically-aligned reservoir, the sealing portion extending around a perimeter of the capture and sealing member and including a plurality of sealing member openings, a cover member including a mounting surface having a plurality of fastener openings and a concave surface configured to receive the vertically-aligned reservoir, and a plurality of fasteners configured to couple the cover member to the capture and sealing member. The mounting surface of the cover member and the sealing portion of the capture and sealing member are compressively secured together to retain the fluid in the reservoir between the cover and the capture and sealing member.

In some aspects, the sealing portion is a compression gasket.

In some aspects, the sealing portion includes a plurality of sealing member openings configured to align with the plurality of fastener openings formed in the mounting surface of the cover member.

In some aspects, the plurality of fasteners includes a plurality of cover bolts.

In some aspects, the plurality of fastener openings in the capture and sealing member are evenly distributed around the perimeter of the capture and sealing member.

In another aspect of the present disclosure, an automotive vehicle includes a housing enclosing a rotatable component and a fluid capture system. The fluid capture system includes a capture member including a recessed surface defining a reservoir and a sealing surface extending around a perimeter of the recessed surface, the sealing surface including a plurality of fastener openings formed in the sealing surface, a sealing member adjacent to and coupled with the sealing surface of the capture member, the sealing member encircling the plurality of fastener openings, a cover member adjacent to the sealing member, and at least one fastener coupling the cover member to the capture member. The cover member and the capture member compressively secure the sealing member therebetween to retain a fluid in the reservoir between the cover member and the capture member.

In some aspects, the capture member includes an edge formed in the recessed surface, the edge defining a redistribution opening to redistribute the fluid to the rotatable component.

In some aspects, the sealing member is a compression gasket that includes a plurality of sealing member openings configured to align with the plurality of fastener openings formed in the sealing surface of the capture member.

In some aspects, the sealing member is removably coupled to the sealing surface of the capture member.

In some aspects, the sealing member is adhesively coupled to the sealing surface of the capture member.

### BRIEF DESCRIPTION OF THE DRAWINGS

The present disclosure will be described in conjunction with the following figures, wherein like numerals denote like elements.

FIG. 1 is an exploded perspective view of an integrated oil capture and gasket system, according to an embodiment of the disclosure.

FIG. 2 is a perspective view of the integrated oil capture and gasket system of FIG. 1, according to an embodiment of the disclosure.

FIG. 2A is an enlarged view of the gasket and component interface, according to an embodiment of the disclosure.

FIG. 3 is a perspective view of the integrated oil capture and gasket system of FIG. 1, including a cover member, according to an embodiment of the disclosure.

FIG. 4 is an exploded perspective view of an integrated oil capture and gasket system, according to another embodiment of the disclosure.

FIG. 5 is a perspective view of the integrated oil capture and gasket system of FIG. 4, according to an embodiment of disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

For a component, such as a rear drive module (RDM) for a vehicle, oil capture and redistribution are desired. Embodiments discussed herein integrate the capture, redistribution, and sealing functions with an integrated oil capture member and gasket system.

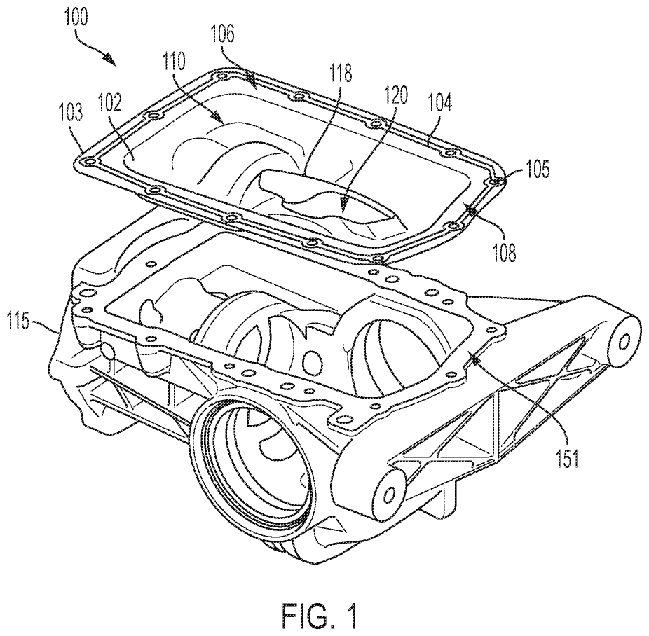

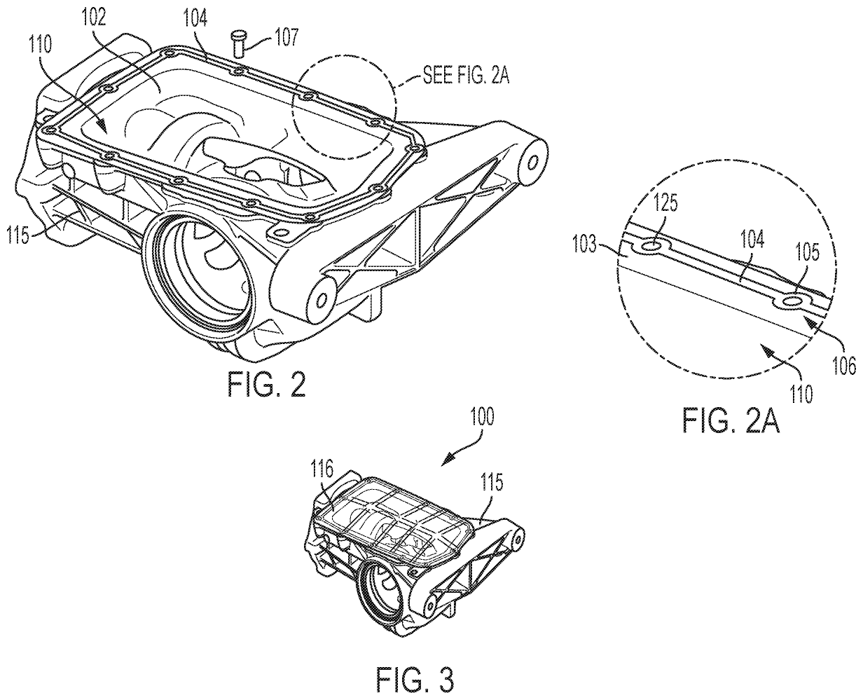

FIGS. 1, 2, and 2A illustrate an integrated oil capture and gasket system 100, according to an embodiment of the disclosure. In the embodiment shown in FIG. 1, the system 100 is configured for use with an RDM housing 115. The RDM housing 115 houses a rear drive module including one or more rotating members, such as gears, and further encloses a lubrication fluid, such as oil. The housing 115 includes a mounting surface 151.

The system 100 includes a capture member 102 and a sealing member 104 integrated or coupled together by adhesive, etc. for example and without limitation. In various embodiments, the capture member 102 is a tray having a recessed surface or reservoir to capture, retain, and redistribution a fluid, such as oil. The capture member 102 includes a mounting lip 103 extending around the perimeter of the recessed surface of the capture member 102. An upper surface of the mounting lip 103 is a sealing surface 106. A plurality of openings 125 extend through the mounting lip 103. The plurality of openings 125 are configured to receive a mechanical fastener, such as a screw, bolt, etc. to couple the capture member 102 to a housing, such as the housing 115.

A first edge 108 of the capture member 102 defines a recessed surface 110 that forms a fluid reservoir. The first edge 108 is adjacent to and contiguous with the sealing surface 106 and the recessed surface 110 such that the sealing surface 106 and the recessed surface 110 are non-coplanar. A second edge 118 defines a redistribution opening 120 in the capture member 102. The redistribution opening 120 permits the capture of fluid slung or flung from a rotating component, such as oil flung from a rotating gear. The fluid is captured and retained within the capture member 102. The fluid is allowed to be redistributed by interfacing with the rotating component, or via other holes or openings in the capture member 102. In various embodiments, the design of the capture member 102 is based on the configuration of the housing to which the capture member 102 is mounted. The number, orientation, size, and placement of distribution ports or openings within the capture member 102 is configurable depending on the application of the capture member 102.

The sealing member 104 is adjacent to the sealing surface 106, and, in various embodiments, is removably coupled to the sealing surface 106. In various embodiments, the sealing member 104 is a gasket, and in some embodiments, is a compression gasket that accepts loads from cover bolts. In various embodiments, the sealing member 104 is formed from any type of sealing material, such as rubber, for example and without limitation. The sealing member 104 includes a plurality of openings 105 configured to align with the openings 125 in the capture member 102. The openings 105, 125 are configured to receive fasteners 107, such as cover bolts, to secure a cover to the housing 115. The sealing member 104 surrounds each of the openings 125 in order to seal the cover and the capture member 102. In various embodiments, the openings 105 align with the openings 125 in the capture member 102 and the openings in the mounting surface 151 of the housing 115 (not shown). In various embodiments, the sealing member 104 is coupled to the sealing surface 106, such as by an adhesive, for example and without limitation.

FIG. 3 illustrates the system 100 fully assembled with the housing 115 and a cover member 116. Fasteners, such as bolts, secure the cover member 116 to the capture member 102, with the sealing member 104 sandwiched or compressed therebetween to seal the interface between the capture member 102 and the cover member 116. In various embodiments, the sealing member 104 is held in place between the capture member 102 and the cover member 116 due to the pressure applied from the plurality of fasteners.

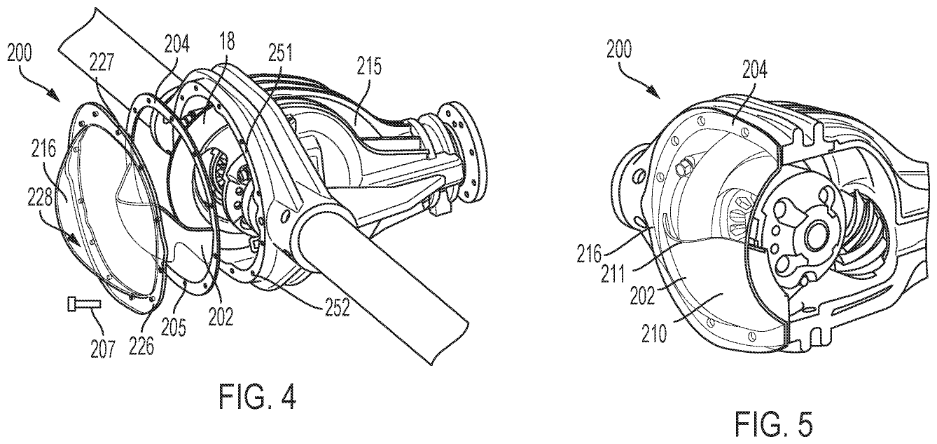

FIGS. 4 and 5 illustrate a second embodiment of an integrated oil capture and gasket system 200, according to an embodiment of the disclosure. In the embodiment shown in FIGS. 4 and 5, the system 200 is configured for use with a vertically split cover type axle housing 215. The housing 215 houses one or more rotating members 18, such as gears, and further encloses a lubrication fluid, such as oil. The housing 215 includes a mounting surface 251.

The system 200 includes a capture and sealing member 202 formed as a single component. In various embodiments, the capture and sealing member 202 is a vertical half tray having a vertically aligned reservoir 210 to capture, retain, and redistribution a fluid, such as oil. The fluid is captured and retained within the reservoir 210 of the capture and sealing member 202. The fluid is allowed to be redistributed by interfacing with the rotating component 18 above the edge of the reservoir 210. In various embodiments, the design of the capture and sealing member 202 is based on the configuration of the housing to which the capture and sealing member 202 is mounted.

A sealing portion 204 of the capture and sealing member 202 extends around a perimeter of the capture and sealing member 202 and is adjacent to the mounting surface 251 of the housing 215. In various embodiments, the sealing portion 204 is a gasket, and in some embodiments, is a compression gasket that accepts loads from a plurality of fasteners, such as cover bolts. In various embodiments, the sealing portion 204 is formed from any type of sealing material, such as rubber, for example and without limitation. The sealing portion 204 includes a plurality of openings 205 configured to receive fasteners 207, such as cover bolts, to secure a cover 216 to the housing 215. The cover 216 includes a mounting surface 226 having a plurality of fastener openings 227 and a concave surface 228. The concave surface 228 is configured to receive the vertically aligned reservoir 210. The sealing portion 204 surrounds each of the openings 205 in order to seal the cover 216 and the capture and sealing member 202. In various embodiments, the openings 205 align with openings 252 in the mounting surface 251.

FIG. 5 illustrates the system 200 fully assembled with the housing 215 and the cover 216. Fasteners 207, such as bolts, secure the cover 216 to the capture and sealing member 202, with the sealing portion 204 sandwiched or compressed therebetween to seal the interface between the capture and sealing member 202 and the cover 216. In various embodiments, the sealing portion 204 seals the interface between the capture and sealing member 202 and the cover 216 due to the pressure applied from the plurality of fasteners 207. The captured fluid is retained between the cover 216 and the reservoir 210 of the capture and sealing member 202 and is redistributed to the rotating components of the housing 215 over an edge 211 of the reservoir 210.

While the embodiments discussed herein are applied to housings for transmission components, it is understood that these embodiments may be used to capture, retain, and redistribute fluid for other components including fluid capture and redistribution features.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic; parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for retaining and redistributing a fluid, comprising:
a capture member including a recessed surface defining a reservoir and a sealing surface extending around a perimeter of the recessed surface, the sealing surface including a plurality of fastener openings;
a sealing member adjacent to and coupled with the sealing surface of the capture member, the sealing member encircling the plurality of fastener openings;
a cover member coupled to the capture member; and
at least one fastener coupling the cover member to the capture member;
wherein the cover member and the capture member compressively secure the sealing member therebetween to retain the fluid between the cover member and the capture member.

2. The system of claim 1, wherein the capture member includes a first edge adjacent to and contiguous with each of the sealing surface and the recessed surface such that the sealing surface and the recessed surface are non-coplanar.

3. The system of claim 1, wherein the capture member includes a second edge defining a redistribution opening to redistribute captured fluid.

4. The system of claim 3, wherein the second edge is formed in the recessed surface of the capture member.

5. The system of claim 1, wherein the sealing member is a compression gasket.

6. The system of claim 1, wherein the sealing member includes a plurality of sealing member openings configured to align with the plurality of fastener openings formed in the sealing surface of the capture member.

7. The system of claim 1, wherein the sealing member is adhesively coupled to the sealing surface of the capture member.

8. The system of claim 1, wherein the sealing member is removably coupled to the sealing surface of the capture member.

9. The system of claim 1, wherein the at least one fastener is a cover bolt.

10. The system of claim 1, wherein the plurality of fastener openings in the capture member are evenly distributed around the recessed surface.

11. A system for retaining and redistributing a fluid, comprising:
a capture and sealing member including a sealing portion and a vertically aligned reservoir, the sealing portion extending around a perimeter of the capture and sealing member and including a plurality of sealing member openings;
a cover member including a mounting surface having a plurality of fastener openings and a concave surface configured to receive the vertically aligned reservoir; and
a plurality of fasteners configured to couple the cover member to the capture and sealing member;
wherein the mounting surface of the cover member and the sealing portion of the capture and sealing member are compressively secured together to retain the fluid in the reservoir between the cover and the capture and sealing member.

12. The system of claim 11, wherein the sealing portion is a compression gasket.

13. The system of claim 11, wherein the sealing portion includes a plurality of sealing member openings configured to align with the plurality of fastener openings formed in the mounting surface of the cover member.

14. The system of claim 11, wherein the plurality of fasteners includes a plurality of cover bolts.

15. The system of claim 11, wherein the plurality of fastener openings in the capture and sealing member are evenly distributed around the perimeter of the capture and sealing member.

16. An automotive vehicle, comprising:
a housing enclosing a rotatable component; and
a fluid capture system, comprising:
a capture member including a recessed surface defining a reservoir and a sealing surface extending around a perimeter of the recessed surface, the sealing surface including a plurality of fastener openings formed in the sealing surface;
a sealing member adjacent to and coupled with the sealing surface of the capture member, the sealing member encircling the plurality of fastener openings;
a cover member adjacent to the sealing member; and
at least one fastener coupling the cover member to the capture member;
wherein the cover member and the capture member compressively secure the sealing member therebetween to retain a fluid in the reservoir between the cover member and the capture member.

17. The automotive vehicle of claim 16, wherein the capture member includes an edge formed in the recessed surface, the edge defining a redistribution opening to redistribute the fluid to the rotatable component.

18. The automotive vehicle of claim 16, wherein the sealing member is a compression gasket that includes a plurality of sealing member openings configured to align with the plurality of fastener openings formed in the sealing surface of the capture member.

19. The automotive vehicle of claim 16, wherein the sealing member is removably coupled to the sealing surface of the capture member.

20. The automotive vehicle of claim 16, wherein the sealing member is adhesively coupled to the sealing surface of the capture member.
